(19) United States
(12) Patent Application Publication
(10) Pub. No.: US 2025/0214413 A1
(43) Pub. Date: Jul. 3, 2025

(54) SHUT-OFF DEVICE ADAPTED TO GENERATE A LIGHTING FUNCTION AND FRONT FACE ASSEMBLY COMPRISING SUCH A DEVICE

(71) Applicant: Valeo Systemes Thermiques, Le Mesnil Saint-Denis (FR)

(72) Inventors: Vijendrakumar Pawanprasad, Chennai (IN); Sebastien Velasco, Chennai (IN); Karim Arab, Le Mesnil Saint Denis Cedex (FR); Laura Marion, Le Mesnil Saint Denis Cedex (FR); Sebastien Piroche, Bobigny Cedex (FR)

(73) Assignee: Valeo Systemes Thermiques, Le Mesnil Saint-Denis (FR)

(21) Appl. No.: 18/398,143

(22) Filed: Dec. 28, 2023

(30) Foreign Application Priority Data
Dec. 28, 2023 (FR) 2214586

(51) Int. Cl. B60K 11/08; B60Q 1/00; B60Q 1/26; F21S 43/14; F21S 43/249; F21Y 105/12; F21Y 115/10

(52) U.S. Cl. CPC B60K 11/085; B60Q 1/0017; B60Q 1/2661; F21S 43/14; F21S 43/249; F21Y 2105/12; F21Y 2115/10

(57) ABSTRACT

A shut-off device for a front face assembly configured to be fitted in a vehicle is disclosed. The shut-off device is adapted to take up a first position in which the shut-off device allows the passage of air flow through the front face assembly and a second position in which the shut-off device prevents the passage of air flow through the front face assembly. The shut-off device extends mainly in a longitudinal direction L. The shut-off device includes at least an opening, a light guide, and a light source. The opening, light guide, and light source extend mainly in the longitudinal direction L. The light guide is at least partially housed in the opening.

The present invention relates to the field of thermal management devices, and more particularly a shut-off device for a front face assembly of a vehicle, in particular a motor vehicle, intended to have an air flow passing through it, the shut-off device being adapted to generate a lighting function.

Vehicles, notably motor vehicles, are commonly equipped with a device adapted to have an air flow passing through it. This air flow conventionally passes through a front face assembly which may include a front face heat exchanger, such as a condenser of an air-conditioning system and/or a radiator of a cooling system.

Such thermal management devices may include systems for controlling this air flow, such as shut-off devices comprising flaps, generally referred to as AGS, which stands for Active Grille Shutter. They make it possible to adapt the air flow passing through the front face assembly to the needs of the front face heat exchanger, which makes it possible to increase the air penetration coefficient when the heat exchanger does not need to be cooled by the air flow. To sum up, the use of these flaps makes it possible to reduce fuel consumption and, in correlation, vehicle emissions.

Such an adaptation consists of an open configuration of the flaps in which the circulation of the air flow from the outside, in the direction of the heat exchanger, is allowed and a closed configuration in which this circulation of the air flow is prevented, which makes it possible in particular to reduce the aerodynamic drag of the vehicle.

It is moreover known practice to change the look of the front face assembly by means of light sources arranged in the vicinity of the management systems. However, these light sources are generally positioned behind the flaps, meaning that they cannot perform their function when the flaps are closed. Moreover, their position behind the flaps significantly increases the bulk of the front face assembly.

The present invention aims to overcome at least these drawbacks by proposing a means for improving the look of the front face assembly of the vehicle while limiting the bulk of the latter.

The present invention thus relates to a shut-off device for a front face assembly intended to be fitted in a vehicle, said shut-off device being adapted to take up a first position in which the shut-off device allows the passage of an air flow through the front face assembly and a second position in which the shut-off device prevents the passage of the air flow through the front face assembly, the shut-off device extending mainly in a longitudinal direction, the shut-off device comprising at least an opening, a light guide and a light source, all three of which extend mainly in said direction, the light guide being at least partially housed in the opening.

The shut-off device is for example a removable flap, capable of taking up at least two positions, positioned angularly at 90° to one another. Such a shut-off device is generally rectangular and it rotates about an axis of rotation which is parallel to the main extension of the shut-off device, in other words its longitudinal extension.

The light guide is configured to direct the light rays emitted by the light source through the opening made in the shut-off device.

According to one example, a main direction of extension of the shut-off device is horizontal. In such a case, the shut-off device is laid flat.

According to another example, a main direction of extension of the shut-off device is vertical. In such a case, the shut-off device is placed upright.

By virtue of this arrangement, the light is visible when the shut-off device is closed. The bulk of the front face assembly comprising the shut-off device is moreover reduced because the light source and the guide form part of the shut-off device.

According to an optional feature of the invention, the light source comprises at least a printed circuit board and a series of light emitting diodes borne by the printed circuit board and aligned in the longitudinal direction of the shut-off device.

According to an advantageous aspect, the light emitting diodes may be controlled selectively with respect to one another. This makes it possible to display various different lighting scenarios.

According to another optional feature of the invention, the shut-off device comprises at least a first shut-off portion and a second shut-off portion which border the opening and which extend in different parallel planes.

This means that the shut-off device has two walls at a distance from one another, depending on the thickness of the device. The area which separates these two walls constitutes the opening, this opening being rectilinear in a direction parallel to the longitudinal direction of the shut-off device.

According to yet another optional feature of the invention, the light guide comprises at least an entry face for the light rays emitted by the light source and an exit face for said light rays, the exit face for said light rays extending between the first shut-off portion and the second shut-off portion.

In other words, the exit face for the light rays of the light guide joins the first shut-off portion and the second shut-off portion. That is to say, this exit face for the light rays continues an outer face of each shut-off portion.

According to one embodiment, the exit face for the light rays is curved, seen in cross section. Such a structure makes it possible to angularly distribute the light rays which emerge from the exit face for the light rays.

According to an optional feature of the invention, the entry face for the light rays is flat. This entry face for the light rays is placed directly facing the light source, such that the direction of the light rays entering the light guide is not changed.

According to another optional feature of the invention, the entry face for the light rays extends in a plane parallel to one and/or the other of the shut-off portions which border the opening. The bulk of the shut-off device and hence of the front face assembly comprising same is thus reduced strictly to the minimum.

According to yet another optional feature of the invention, the light guide comprises a retention base arranged between one of the shut-off portions which borders the opening and a cover secured to the shut-off device.

Such a base contributes to the mechanical retention of the light guide relative to the shut-off portions of the shut-off device.

The cover is for example a plate arranged at the rear of the shut-off device, the light guide and the light source then being interposed between this plate and one of the shut-off portions of the shut-off device. This cover is secured to the shut-off device by any means such as the use of screws, rivets, adhesive bonding, welding or heading.

According to yet another optional feature of the invention, the shut-off device comprises two openings and two light guides arranged symmetrically about a median plane of the shut-off device, each of the light guides being at least partially housed in one of the openings. The median plane is for example horizontal if the main direction of extension of the shut-off device is horizontal. According to another example, the median plane is vertical if the main direction of extension of the shut-off device is vertical.

When the shut-off device comprises only two light guides and two openings, these two light guides bear against the same shut-off portion which borders these two openings.

The invention also relates to a front face assembly comprising a frame which forms a surround for the shut-off device or devices as described above. When this or these devices are open, it is inside this surround that the air flow circulates.

According to an optional feature of the invention, the passage of the shut-off device from one of its positions to the other is brought about by rotating the shut-off device about an axis of rotation parallel to the longitudinal direction of the shut-off device.

According to another optional feature of the invention, the front face assembly comprises a plurality of shut-off devices arranged side by side and bearing in pairs on one another when the shut-off devices are placed in their second position. This means that the frame does not include a bar against which two shut-off devices bear. On the contrary, two immediately adjacent shut-off devices are touching when they are in their closed position.

The area which separates two adjacent shut-off devices which are open is a space for circulation of the air flow, such a space being obstructed jointly by two adjacent shut-off devices. In the second position of two adjacent shut-off devices, a portion of each of said shut-off devices comes into contact with one another in such a way as to prevent the air flow from passing through the circulation space.

According to one embodiment of the front face assembly, the shut-off devices may be controlled selectively. In other words, the assembly is configured such that one of the shut-off devices is open when another is closed. This makes it possible adapt the external air flow rate to the cooling requirements of the front face heat exchanger, while maintaining at least partially the effect on the air penetration coefficient.

According to one embodiment of the invention, the front face assembly comprises a light module borne by the frame and configured to emit light rays at least in the direction of the shut-off device. Such a light module is a lighting member in addition to the light source or sources borne by the shut-off device. This light module makes it possible to light up the outer face of the shut-off device.

According to this embodiment, the light module comprises at least a first strip light and a second strip light arranged on either side of the shut-off device, or shut-off devices where applicable.

According to one example, the first strip light is vertically above the shut-off device, whereas the second strip light is vertically below the shut-off device.

According to another alternative or complementary example, the first strip light is laterally to the left of the shut-off device, while the second strip light is laterally to the right of the shut-off device.

Other features and advantages of the invention will become more clearly apparent from the following description and from a number of exemplary embodiments provided by way of non-limiting indication with reference to the accompanying schematic drawings, in which:

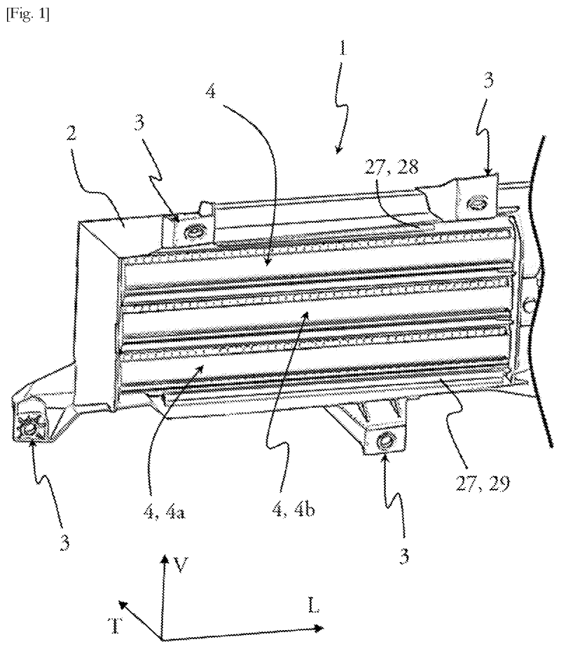

FIG. 1 is an end-on perspective view of the front face assembly according to the invention;

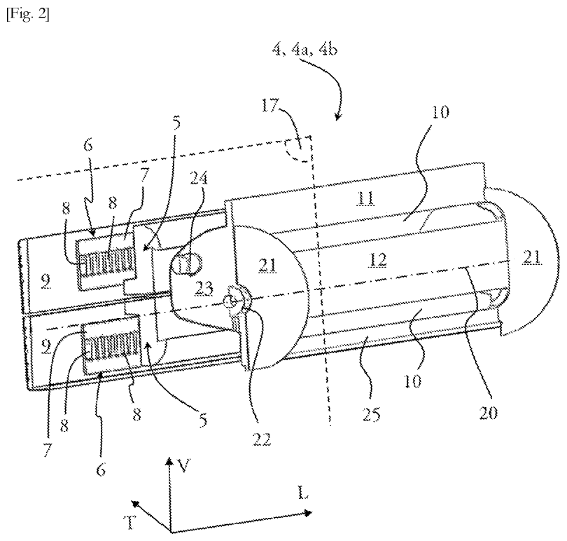

FIG. 2 is an exploded view of a shut-off device of FIG. 1;

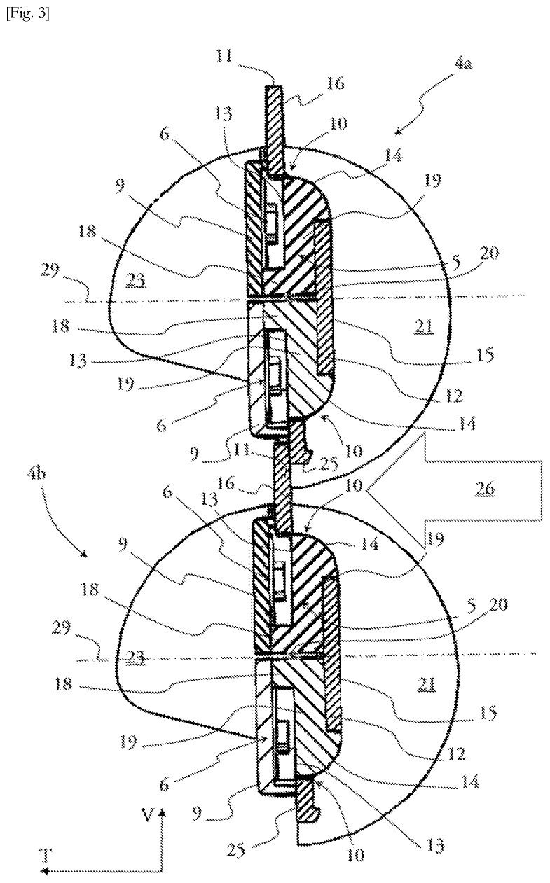

FIG. 3 is a view of two shut-off devices shown in FIG. 1, viewed according to a cross section 17 depicted in FIG. 2 and in a closed position;

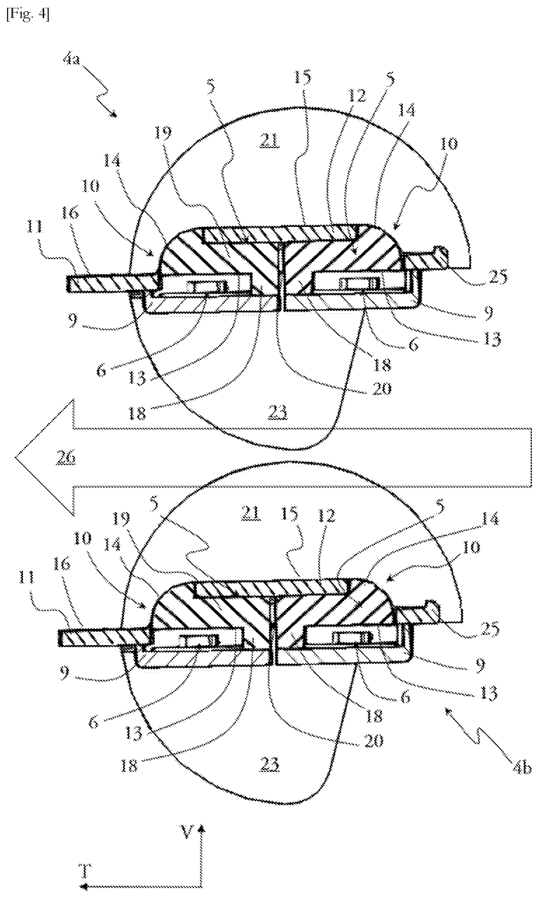

FIG. 4 is a view of two shut-off devices shown in FIG. 3, viewed according to a cross section 17 depicted in FIG. 2 and in an open position.

FIG. 1 shows part of a front face assembly 1. More specifically, the part of the front face assembly 1 visible in FIG. 1 is a left-hand half of the front face assembly. This front face assembly 1 being of symmetrical design, it also comprises a right-hand half which is identical to the left-hand half. The description set out below regarding the left-hand half is of course transposable to the right-hand half of the front face assembly.

Such a front face assembly 1 comprises a frame 2 which forms a peripheral casing of the front face assembly 1. Such a frame is the piece which holds all the components of the front face assembly 1. This piece is also used to secure the front face assembly to a vehicle, for example a motor vehicle.

For this purpose the frame 2 comprises attachment means 3 the function of which is to connect the front face assembly to the front face of said vehicle. According to the example shown in FIG. 1, an attachment means 3 takes the form of an attachment lug which has a hole and protrudes from the casing.

The front face assembly 1 further comprises at least one shut-off device 4 for shutting off the air flow which passes through the front face assembly 1. In the case at hand, the part of the front face assembly 1 comprises three shut-off devices 4 which are borne by the frame 2.

Each shut-off device 4 is adapted to take up a first position, or open position, in which it allows an air flow to pass through the front face assembly 1, and a second position, or closed position, in which it prevents the air flow from passing through the front face assembly 1.

The frame 2 of the front face assembly 1 bears at least one light module 27 which is arranged in such a way as to light up an outer part of the shut-off device 4, in other words a part which receives the external air flow when the shut-off device is in the closed position, that is to say in its second position.

Such a light module 27 participates in the creation of lighting scenarios that the front face assembly can generate. According to one example, the light module 27 comprises a first strip light 28 and a second strip light 29 arranged on either side of the shut-off device 4, and more generally on either side of the plurality of shut-off devices 4a, 4b, when the front face assembly 1 has these. These strip lights 27, 28 are composed of light emitting diodes, of various colours, the light intensity of which may be adjusted.

According to one example, the first strip light 28 is secured to the frame 2 by being attached vertically above the shut-off device 4, 4a, 4b and the second strip light 29 is attached to the frame, being vertically below the shut-off device or devices 4, 4a, 4b. Naturally, an arrangement to the left or right of this or these shut-off devices 4, 4a, 4b falls within the scope of the invention.

In the description below, it is taken for granted that any description of a technical aspect in relation to a single shut-off device is transposable to another shut-off device, or to all the shut-off devices 4 of the front face assembly 1 according to the invention.

According to the example of FIG. 1, the shut-off device 4 extends mainly in a longitudinal direction L, identifiable in an orthonormal frame of reference L, V, T depicted in FIG. 1. This main direction of extension L is in this case horizontal, since the shut-off device 4 is generally laid flat. Note that this arrangement is not limiting and that the main direction of extension may also be vertical, and in a such a case the shut-off device is generally put in place vertically.

Whatever its position, this shut-off device 4 is capable of taking up two end positions, and a multitude of intermediate positions, by virtue of a rotation about an axis of rotation 20. One end position is a first position in which the shut-off device 4 allows an air flow to pass through the front face assembly 1. This first position is shown in FIG. 4.

Another end position is a second position in which the shut-off device 4 prevents the air flow from passing through the front face assembly 1. FIG. 1 and FIG. 3 depict the shut-off device 4 when it is in its second position.

FIG. 2 shows in detail the components of the shut-off device 4. The latter comprises at least one light guide 5 and one light source 6. In the example illustrated here, the shut-off device 4 comprises two light guides 5 positioned top to tail, and two light sources 6.

According to the invention, the light guide 5 and the light source 6 both extend in the longitudinal direction of the shut-off device 4, in other words its main direction of extension. The light guide 5 and the light source 6 take the form of a strip extending parallel to the longitudinal direction L.

The light source 5 comprises at least one printed circuit board 7 to which a series of light emitting diodes 8 is attached. A light source 5 thus comprises several light emitting diodes 8 which can light up and go out simultaneously or selectively, depending on the lighting scenario chosen.

The light emitting diodes 8 are arranged one after the other along a virtual line which is parallel to the longitudinal direction L. Such light emitting diodes 8 may emit white light or red, green or blue light, and the intensity of the light radiation of each of the light emitting diodes 8 may be controlled individually.

The light source 6 is borne by a cover 9 constituting the shut-off device 4. In the case at hand, the shut-off device 4 comprises two covers 9 which each bear a light source 6.

The printed circuit board 7 is for example adhesively bonded to this cover 9 and the latter closes off a rear part of the shut-off device 4.

According to the invention, the shut-off device 4 comprises at least one opening 10 which extends substantially parallel to the longitudinal direction L of the shut-off device 4. Such an opening 10 takes the form of a slit made in a blocking wall of the shut-off device 4. According to the example of FIG. 1, the shut-off device 4 comprises two openings 10.

The shut-off device 4 comprises a first shut-off portion 11 and a second shut-off portion 12. These two portions border the opening 10, extending along the latter. These portions are the parts of the shut-off device 4 which block the passage of the air flow through the front face assembly according to the invention.

According to one example, this first shut-off portion 11 and this second shut-off portion 12 are flat. They are each inscribed in a plane, these two planes being in this case different parallel planes. This first shut-off portion 11 and this second shut-off portion 12 form bands offset in the transverse direction T and in the vertical direction V, between which the opening 10 is made.

According to the invention and as can be seen in FIG. 3 or 4, the light guide 5 extends at least partially in the opening 10. This ensures that the light rays emerge at the shut-off device 4, even when the latter is in its second position, in other words closed.

Advantageously, the entire opening 10 is taken up by the light guide 5, both longitudinally and vertically.

As can be seen in FIGS. 3 and 4, the light guide 5 comprises an entry face 13 for the light rays coming from the light source 6 and an exit face 14 via which the light rays which entered via the entry face 13 exit from the light guide 5. The entry face 13 for the light rays is generally flat and extends in a plane parallel to the plane in which the first shut-off portion 11 or the second shut-off portion 12 is inscribed. The light source 6 is installed in line with this entry face 13 for the light rays.

The exit face 14 for the light rays has a curved profile, seen in the cross section shown in FIG. 3 or in FIG. 4. This exit face 14 for the light rays joins an outer face 15 of the second shut-off portion 12 to an outer face 16 of the first shut-off portion 11.

The light guide 5 further comprises a retention base 18 which is sandwiched between the cover 9 and the second shut-off portion 12. The light guide 5 also comprises a body 19 which, on one side, protrudes from the retention base 18 and on the other side ends in the exit face 14 for the light rays. This body 19 is delimited on one side by the entry face 13 for the light rays and it comprises, on the other side, a recess in which the second shut-off portion 12 is placed. The exit face 14 for the light rays and the retention base 18 are at two opposite ends of the body 19.

The path of the light rays is as follows: the light rays coming from the light source 6 enter the light guide 5 via the entry face 13, without changing direction. These light rays move through the body 19 by total reflection, and reach the exit face 14, where the light rays are scattered in an angular sector corresponding to the angular sector of the curve followed by the exit face 14.

The cover 19, the first shut-off portion 11, the entry face 13 for the light rays and the retention base 18 delimit a cavity where the light rays can only escape via the entry face 13 for the light rays.

When the shut-off device 4 comprises only two light guides 5, these two light guides 5 are fitted top to tail, being separated from one another by an air gap, so as to prevent transmission of light rays between two light guides 5. These two light guides 5 are thus arranged symmetrically about a median plane 29 containing the longitudinal direction L and the transverse direction T of the orthonormal frame of reference.

The two light guides 5 both bear against the same second shut-off portion 12. In other words, a single second shut-off portion 12 delimits two openings 10, a first opening 10 being filled by a first light guide 5 and a second opening 10 being filled by a second light guide 5, distinct from the first light guide. Thus, the shut-off device 4 emits light rays on either side of its axis of rotation, but on the same side of the shut-off portions 11 and 12.

FIG. 2, FIG. 3 and FIG. 4 also show the presence of two flanges 21 which longitudinally delimit the shut-off device 4. These flanges 21 have the general shape of a half-disc and serve to guide the rotation of the shut-off device 4, by contact of the flange on the frame 2 of the front face assembly 1.

FIG. 2 shows the presence of a rotation bearing 22 of the shut-off device 4. The latter also comprises a lever arm 23 and a lever 24 which serve to transmit a force to cause the shut-off device to go from its first position to its second position, and vice versa.

In FIGS. 2 to 4, note that the shut-off device 4 comprises a tongue 25 which forms a flat rectilinear band, which is inscribed in a plane parallel to the plane in which the first shut-off portion 11 or the second shut-off portion 12 is inscribed.

The plane of this tongue 25 is for example distinct from the planes of the first shut-off portion 11 or the second shut-off portion 12, being for example inserted transversely between these two planes. In such a situation, the cover 9 which is in contact with the tongue 25 comprises a return which closes off the cavity in which the light rays are contained.

In FIG. 3, which shows a first shut-off device 4a and a second shut-off device 4b arranged one beside the other and in their second position, it can be seen the first shut-off portion 11 of the second shut-off device 4b bears against the tongue 25 of the first shut-off device 4a.

The first shut-off portion 11 of the first shut-off device 4a extends in a plane which is coincident with a plane in which the first shut-off portion 11 of the second shut-off device 4b extends. The same applies to the second shut-off portions 12 and the tongues 25. The shut-off devices 4a, 4b are arranged thus when it is necessary to prevent an air flow 26 from passing through the front face assembly 1 according to the invention.

Sealing against the air flow 26 is achieved by contact between one shut-off device 4 and the other.

FIG. 4 shows the first shut-off device 4a and the second shut-off device 4b arranged one beside the other and in their first position, in other words allowing circulation of the air flow 26 through the front face assembly 1 according to the invention. Compared to FIG. 3, the shut-off devices 4a and 4b have been turned through 90°, or substantially 90°, in the anti-clockwise direction. The first shut-off portion 11 of the first shut-off device 4a extends in a plane which is distinct from and advantageously parallel to a plane in which the first shut-off portion 11 of the second shut-off device 4b extends. The same applies to the second shut-off portions 12 and the tongues 25.

The present invention clearly achieves the aims set by proposing a front face assembly capable of controlling the air flow passing through it while allowing the creation of various lighting scenarios, all with a particularly small bulk.

1. A shut-off device for a front face assembly configured to be fitted in a vehicle,
wherein the shut-off device is adapted to take up a first position in which the shut-off device allows the passage of an air flow through the front face assembly, and a second position in which the shut-off device prevents the passage of the air flow through the front face assembly,
wherein the shut-off device extends mainly in a longitudinal direction L,
wherein the shut-off device comprises:
at least an opening;
a light guide; and
a light source,
wherein the opening, light guide, and light source extend mainly in the longitudinal direction L,
wherein the light guide is at least partially housed in the opening.

2. The shut-off device according to claim 1,
wherein the light source comprises at least a printed circuit board and a series of light emitting diodes borne by the printed circuit board and aligned in the longitudinal direction L of the shut-off device.

3. The shut-off device according to claim 1,
wherein the shut-off device comprises at least a first shut-off portion and a second shut-off portion which border the opening and which extend in different parallel planes, and
wherein the light guide comprises at least an entry face for the light rays emitted by the light source and an exit face for the light rays,
wherein the exit face for the light rays extends between the first shut-off portion and the second shut-off portion.

4. The shut-off device according to claim 3,
wherein the exit face is curved, seen in cross section.

5. The shut-off device according to claim 3,
wherein the entry face for the light rays extends in a plane parallel to one or the other of the shut-off portions which border the opening.

6. The shut-off device according to claim 3,
wherein the light guide comprises:
a retention base arranged between one of the shut-off portions which borders the opening, and
a cover secured to the shut-off device.

7. The shut-off device according to claim 3,
wherein the shut-off device comprises two openings and two light guides arranged symmetrically about a median plane of the shut-off device,
wherein each of the light guides is at least partially housed in one of the openings.

8. The shut-off device according to claim 7,
wherein the two light guides bear against the same shut-off portion which borders two openings.

9. A front face assembly comprising a shut-off device according to claim 1,
wherein the front face assembly comprises:
at least one frame bearing the shut-off device, and
a light module borne by the frame and configured to emit light rays at least in the direction of the shut-off device.

10. The front face assembly according to claim 9,
wherein the light module comprises at least a first strip light and a second strip light arranged on either side of the shut-off device.
